(19) United States
(12) Patent Application Publication
(10) Pub. No.: US 2023/0256508 A1
(43) Pub. Date: Aug. 17, 2023

(54) Method for producing a green body and method for further processing the green body to form a machining segment

(71) Applicant: Hilti Aktiengesellschaft, Schaan (LI)

(72) Inventors: Thorsten KLEIN, Balgach (CH); Matthaeus HOOP, Eschen (LI); Thomas BRITT, Flums (CH); Jens STRACKE, Feldkirch (AT); Steven MOSELEY, Nenzing-Gurtis (AT); Jozsef SZABO, KECSKEMET (HU)

(21) Appl. No.: 18/010,597

(22) PCT Filed: Jun. 10, 2021
(86) PCT No.: PCT/EP2021/065618

§ 371 Date: Dec. 15, 2022

(30) Foreign Application Priority Data
Jun. 24, 2020 (EP) 20181955.4

(51) Int. Cl. B22F 3/02; B22F 3/10; B24D 5/12

(52) U.S. Cl. CPC B22F 3/02; B22F 3/10; B24D 5/12; B22F 2998/10; B22F 2005/001

(57) ABSTRACT

Method for producing a green body for a machining segment (51) from a powdered or granular first matrix material (56), first hard material particles (57) and second hard material particles (58), the machining segment being connected by an underside (61) to a basic body of a machining tool. The machining segment (51) has a projection of the second hard material particles (58) with respect to the first matrix material (56) on the side surfaces.

### TECHNICAL FIELD

The present invention relates to a method for producing a green body and to a method for further processing the green body to form a machining segment.

### BACKGROUND

Machining tools, such as core drill bits, saw blades, abrasive disks and cut-off grinding chains, comprise machining segments that are attached to a tubular, disk-shaped or annular basic body, the machining segments being connected to the basic body by welding, brazing or adhesive bonding. Depending on the machining method of the machining tool, machining segments that are used for core drilling are referred to as drilling segments, machining segments that are used for sawing are referred to as sawing segments, machining segments that are used for abrasive removal are referred to as abrading segments and machining segments that are used for cut-off grinding are referred to as cut-off grinding segments.

### SUMMARY OF THE INVENTION

Machining segments for core drill bits, saw blades, abrasive disks and cut-off grinding chains are produced from a matrix material and hard material particles, where the hard material particles can be randomly distributed or are arranged according to a defined particle pattern in the matrix material. In the case of machining segments with randomly distributed hard material particles, the matrix material and the hard material particles are mixed, and the mixture is poured into a suitable mold and further processed to form the machining segment. In the case of machining segments with hard material particles arranged in a defined manner, a green body is built up in layers from matrix material, in which the hard material particles are arranged according to the defined particle pattern. In the case of machining segments that are to be welded to the basic body of the machining tool, the structure comprising a machining zone and a neutral zone has proven to be successful, since some combinations of matrix material and basic body cannot be welded. The machining zone is built up from a first matrix material and the neutral zone is built up from a second matrix material, which is different from the first matrix material and can be welded to the basic body.

In the case of machining tools which can be designed as a core drill bit, saw blade, abrasive disk or cut-off grinding chain and are intended for the wet or dry machining of concrete materials, increased wear on the side surfaces of the machining segments can occur as a result of friction with the substrate. In this case, the wear depends in particular on the wear properties of the first matrix material. It is known from EP 1 297 928 B1 to reduce the wear on the side surfaces of the machining segments by second hard material particles, which are admixed with the first matrix material as randomly distributed hard material particles. It is disadvantageous that the second hard material particles are embedded completely in the first matrix material. In order to expose the second hard material particles on the side surfaces, the machining segments must be sharpened on the side surfaces.

It is an object of the present invention to provide a method for producing a green body for a machining segment with which machining segments which have low wear on the side surfaces of the machining segments can be produced. Conventional tool components are intended to be used both in the production of the green body and in the further processing of the green body to form the machining segment; it is intended to avoid the use of special tool components. In addition, the intention is for no reworking of the machining segments on the side surfaces to be required.

The method for producing a green body for a machining segment from a powdered or granular first matrix material, first hard material particles and second hard material particles is characterized according to the invention by the following steps:
applying a lower layer of a powdered or granular supporting material, which is different from the first matrix material,
arranging the second hard material particles in the lower layer according to a defined second particle pattern, the second hard material particles being partially embedded in the supporting material,
performing a sequence of a first step and a second step, which is performed N times, N≥1, wherein
   in the first step, a matrix layer consisting of a first region is applied, the first matrix material being applied in the first region, and
   in the second step, the first hard material particles are arranged in the matrix layer according to a defined first particle pattern,
arranging the second hard material particles in the Nth matrix layer according to the defined second particle pattern, the second hard material particles being partially embedded in the first matrix material, and
applying an upper layer of the supporting material, the second hard material particles being completely covered by the supporting material.

The method according to the invention for producing a green body is distinguished by the fact that the green bodies are built up horizontally, i.e. the building-up direction runs perpendicularly to the vertical direction between the underside and upper side of the machining segment. In the horizontal structure, the particle layers of the green body differ from the particle layers of the finished machining segment, which are arranged one on top of the other. The projection of the second hard material particles on the side surfaces of the machining segments is created by means of the powdered or granular supporting material, the supporting material being different from the first matrix material.

The term “supporting material” covers all materials for building up machining segments in which hard material particles can be embedded. The supporting material is in a powdered or granular form and is different from the first matrix material; it serves for embedding the hard material particles completely in powdered or granular material.

When building up the green body, the second hard material particles are arranged in the first matrix material and in the supporting material, so that the second hard material particles are completely embedded in powdered or granular material. Since the second hard material particles in the green body are completely embedded in powdered or granular material, conventional press punches can be used when compacting the green body by cold or hot pressing or when further processing it to form the machining segment by hot pressing.

Green bodies which are produced by means of the method according to the invention for producing a green body can be further processed by means of known methods for further processing the green body to form machining segments. The known methods for further processing include compacting the green body by cold pressing or hot pressing to form a compact body, which is further processed to form the machining segment by free-form sintering or hot pressing, or further processing the green body by free-form sintering or hot pressing to form the machining segment.

In a preferred embodiment, the first hard material particles are arranged in the first matrix material according to the defined first particle pattern. The method according to the invention for producing a green body is suitable for building up machining segments that have a number of particle layers. In the machining, worn first hard material particles are removed and new, deeper-lying first hard material particles are exposed.

In an alternative preferred embodiment, the matrix layer consisting of the first region and a second region is applied, the supporting material being applied in the second region and the first hard material particles being arranged in a transitional region between the first region and the second region. The method according to the invention for producing a green body is suitable for building up machining segments that have a particle layer on the upper side. These machining segments that have first hard material particles with a great projection on the upper side are used in particular for the dry machining of concrete materials.

It is particularly preferred for a supporting material with a melting temperature which is higher than the sintering temperature of the first matrix material to be applied in the second region of the matrix layer. If the melting temperature of the supporting material is higher than the sintering temperature of the first matrix material, the supporting material remains in its powdered or granular state when it is heated up and can be removed from the finished machining segment without any problem after the sintering process.

Alternatively, a supporting material with a melting temperature which is lower than the sintering temperature of the first matrix material is applied in the second region of the matrix layer. If the melting temperature of the supporting material is lower than the sintering temperature of the first matrix material, the supporting material changes its powdered or granular state when it is heated up and liquefies before the first matrix material is sintered. The liquid supporting material can distribute itself in the first matrix material and support the sintering process as an infiltrate.

The invention also relates to a method for further processing a green body produced by the method for producing a green body to form a machining segment, which is connected by an underside to a basic body of a machining tool. In the case of a green body produced by the method according to the invention for producing a green body, the second hard material particles do not have any projection on the side surfaces. The projection of the second hard material particles on the side surfaces is created during the further processing of the green body to form the machining segment.

In a first embodiment, the green body is compacted into a compact body under the action of pressure and the compact body is then further processed to form the machining segment. The green body is compacted into the compact body under the action of pressure between a first press punch, which forms a first side surface of the machining segment, and a second press punch, which forms a second side surface of the machining segment.

It is particularly preferred for the compact body to be further processed to form the machining segment by free-form sintering or hot pressing. Since the second hard material particles in a green body produced according to the invention have been completely embedded in powdered or granular material, conventional press punches can be used for hot pressing, in order to form the side surfaces of the machining segment.

In a second embodiment, the green body is further processed to form the machining segment by free-form sintering or hot pressing. Since the second hard material particles in a green body produced according to the invention have been completely embedded in powdered or granular material, conventional press punches can be used for hot pressing, in order to form the side surfaces of the machining segment.

### BRIEF DESCRIPTION OF THE DRAWINGS

Exemplary embodiments of the invention are described hereinafter with reference to the drawing. It is not necessarily intended for this to illustrate the exemplary embodiments to scale; rather, the drawing is produced in a schematic and/or slightly distorted form where this is useful for purposes of explanation. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be restricted compared to the subject matter claimed in the claims. For given dimensioning ranges, values within the stated limits should also be disclosed as limit values and should be able to be used and claimed as desired. For the sake of simplicity, the same reference signs are used hereinafter for identical or similar parts or parts having an identical or similar function.

In the drawing:

FIGS. 1A, B show two variants of a machining tool designed as a core drill bit;

FIGS. 2A, B show two variants of a machining tool designed as a saw blade;

FIG. 3 shows a machining tool designed as an abrasive disk;

FIG. 4 shows a machining tool designed as a cut-off grinding chain;

FIGS. 5A-C show a green body (FIG. 5A), which is compacted into a compact body (FIG. 5B) and is further processed to form a machining segment (FIG. 5C);

FIGS. 6A-E show the production of the green body of FIG. 5A by means of the method according to the invention for producing a green body;

FIGS. 7A, B show a green body (FIG. 7A), which is further processed to form a machining segment (FIG. 7B); and

FIGS. 8A-F show the production of the green body of FIG. 7A by means of the method according to the invention for producing a green body.

### DETAILED DESCRIPTION

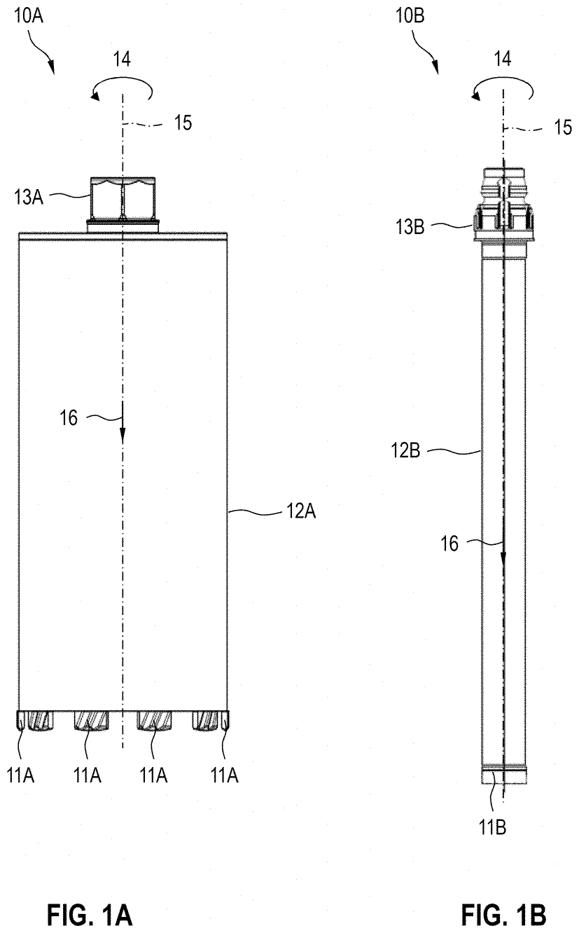

FIGS. 1A, B show two variants of a machining tool designed as a core drill bit 10A, 10B. The core drill bit 10A shown in FIG. 1A is referred to below as the first core drill bit, and the core drill bit 10B shown in FIG. 1B is referred to as the second core drill bit; in addition, the first and second core drill bits 10A, 10B are both included under the term “core drill bit”.

The first core drill bit 10A comprises a number of machining segments 11A, a tubular basic body 12A and a tool fitting 13A. The machining segments 11A, which are used for core drilling, are also referred to as drilling segments, and the tubular basic body 12A is also referred to as a drilling shaft. The drilling segments 11A are fixedly connected to the drilling shaft 12A, for example by screwing, adhesive bonding, brazing or welding.

The second core drill bit 10B comprises an annular machining segment 11B, a tubular basic body 12B and a tool fitting 13B. The annular machining segment 11B, which is used for core drilling, is also referred to as a drilling ring, and the tubular basic body 12B is also referred to as a drilling shaft. The drilling ring 11B is fixedly connected to the drilling shaft 12B, for example by screwing, adhesive bonding, brazing or welding.

The core drill bit 10A, 10B is connected via the tool fitting 13A, 13B to a core drill and, in drilling operation, is driven by the core drill in a direction of rotation 14 about an axis of rotation 15. During the rotation of the core drill bit 10A, 10B about the axis of rotation 15, the core drill bit 10A, 10B is moved along a feed direction 16 into a workpiece to be machined, with the feed direction 16 running parallel to the axis of rotation 15. The core drill bit 10A, 10B creates a drill core and a borehole in the workpiece to be machined.

The drilling shaft 12A, 12B in the exemplary embodiment of FIGS. 1A, B is of a one-piece form and the drilling segments 11A and the drilling ring 11B are fixedly connected to the drilling shaft 12A, 12B. Alternatively, the drilling shaft 12A, 12B may be of a two-piece form, composed of a first drilling shaft section and a second drilling shaft section, with the drilling segments 11A and the drilling ring 11B being fixedly connected to the first drilling shaft section, and the tool fitting 13A, 13B being fixedly connected to the second drilling shaft section. The first and second drilling shaft sections are connected to one another via a releasable connection device. The releasable connection device takes the form for example of a plug-and-twist connection as described in EP 2 745 965 A1 or EP 2 745 966 A1. The design of the drilling shaft as a one-piece or two-piece drilling shaft has no influence on the structure of the drilling segments 11A or of the drilling ring 11B.

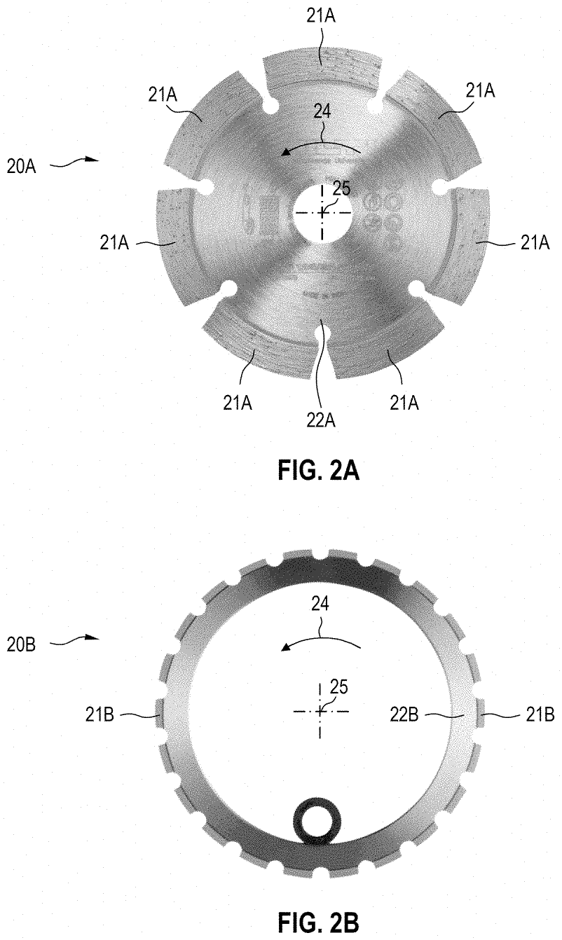

FIGS. 2A, B show two variants of a machining tool designed as a saw blade 20A, 20B. The saw blade 20A shown in FIG. 2A is referred to below as the first saw blade and the saw blade 20B shown in FIG. 2B is referred to as the second saw blade; in addition, the first and second saw blades 20A, 20B are both included under the term “saw blade”.

The first saw blade 20A comprises a plurality of machining segments 21A, a disk-shaped basic body 22A and a tool fitting. The machining segments 21A, which are used for sawing, are also referred to as sawing segments, and the disk-shaped basic body 22A is also referred to as a blade body. The sawing segments 21A are fixedly connected to the blade body 22A, for example by screwing, adhesive bonding, brazing or welding.

The second saw blade 20B comprises a plurality of machining segments 21B, an annular basic body 22B and a tool fitting. The machining segments 21B, which are used for sawing, are also referred to as sawing segments and the annular basic body 22B is also referred to as a ring. The sawing segments 21B are fixedly connected to the ring 22B, for example by screwing, adhesive bonding, brazing or welding.

The saw blade 20A, 20B is connected to a saw via the tool fitting and, in sawing operation, is driven by the saw in a direction of rotation 24 about an axis of rotation 25. During the rotation of the saw blade 20A, 20B about the axis of rotation 25, the saw blade 20A, 20B is moved along a feed direction, the feed direction running parallel to the longitudinal plane of the saw blade 20A, 20B. The saw blade 20A, 20B creates a sawing slit in the workpiece to be machined.

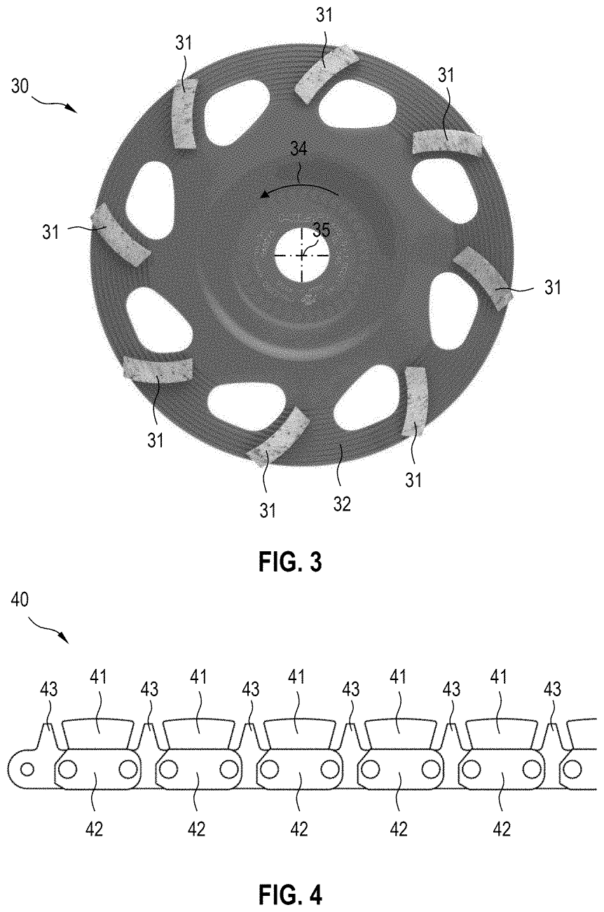

FIG. 3 shows a machining tool designed as an abrasive disk 30. The abrasive disk 30 comprises a number of machining segments 31, a basic body 32 and a tool fitting. The machining segments 31, which are used for abrasive removal, are also referred to as abrading segments, and the disk-shaped basic body 32 is also referred to as a pot. The abrading segments 31 are fixedly connected to the pot 32, for example by screwing, adhesive bonding, brazing or welding.

The abrasive disk 30 is connected via the tool fitting to a tool device and, in abrading operation, is driven by the tool device in a direction of rotation 34 about an axis of rotation 35. During the rotation of the abrasive disk 30 about the axis of rotation 35, the abrasive disk 30 is moved over a workpiece to be machined, the movement running perpendicular to the axis of rotation 35. The abrasive disk 30 removes the surface of the workpiece to be machined.

FIG. 4 shows a machining tool taking the form of a cut-off grinding chain 40. The cut-off grinding chain 40 comprises a number of machining segments 41, a number of basic bodies 42 in the form of links, and a number of connecting links 43. The machining segments 41, which are used for cut-off grinding, are also referred to as cut-off grinding segments, and the basic bodies 42 in the form of links are also referred to as driving links.

The driving links 42 are connected via the connecting links 43. In the exemplary embodiment, the connecting links 43 are connected to the driving links 42 via rivet bolts. The rivet bolts allow a rotation of the driving links 42 relative to the connecting links 43 about an axis of rotation which runs through the center of the rivet bolts. The machining segments 41 are fixedly connected to the driving links 42, for example by screwing, adhesive bonding, brazing or welding.

The cut-off grinding chain 40 is connected via a tool fitting to a tool device and, in operation, is driven by the tool device in a direction of rotation. During the rotation of the cut-off grinding chain 40, the cut-off grinding chain 40 is moved into a workpiece to be machined.

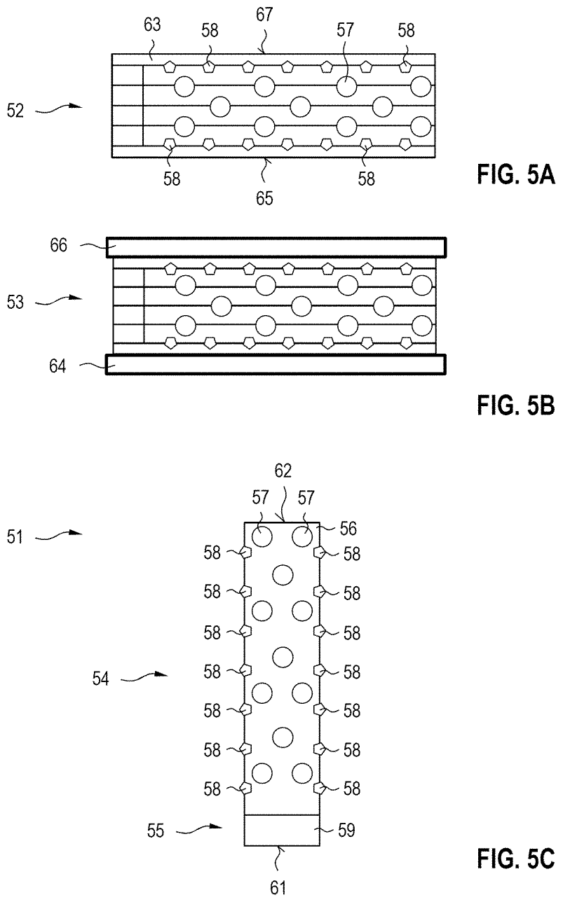

The production of a machining segment 51 (see, e.g., FIGS. 5A-C), which has low wear on the side surfaces, takes place by means of the method according to the invention for the production of a green body and the method for further processing the green body to form a machining segment. In a first stage, a green body 52 is produced; in a second stage, the green body 52 is compacted to form a compact body 53 and, in a third stage, the compact body 53 is further processed to form the machining segment 51. Alternatively, a green body can be produced in a first stage and further processed to form the machining segment in a second stage.

FIGS. 5A-C show the green body 52 (FIG. 5A), the compact body 53 (FIG. 5B) and the machining segment 51 (FIG. 5C). The machining segment 51 is built up from a machining zone 54 and a neutral zone 55. The neutral zone 55 is required if the machining segment 51 is to be welded to the basic body of a machining tool and the combination of matrix material and basic body cannot be welded; in the case of weldable combinations of matrix material and basic body, there is no need for the neutral zone 55.

The machining zone 54 is built up from a powdered or granular first matrix material 56, first hard material particles 57 which are arranged according to a defined first particle pattern, and second hard material particles 58 which are arranged according to a defined second particle pattern, and the neutral zone 55 is built up from a powdered or granular second matrix material 59. The term “matrix material” covers all materials for building up machining segments in which hard material particles can be embedded. Matrix materials may consist of one material or be composed as a mixture of different materials. The term “hard material particles” covers all cutting agents for machining segments; these especially include individual hard material particles, composite parts made up of multiple hard material particles and coated or encapsulated hard material particles.

The machining segment 51 corresponds in structure and composition to the machining segments 11A, 21A, 21B, 31, 41; the machining segment 11B designed as a drilling ring differs from the machining segment 51 by its annular structure. The machining segments can differ from one another in the dimensions and in the curvatures of the surfaces. The structure of the machining segments is explained on the basis of the machining segment 51 and applies to the machining segments 11A, 21A, 21B, 31, 41.

The machining segment 51 comprises the first and second hard material particles 57, 58, which are arranged in the first matrix material 56. “First hard material particles” refer to those hard material particles of the machining segment 51 that machine a substrate, the number of the first hard material particles 57 and the defined first particle pattern being adapted to the requirements of the machining segment 51. Depending on the wear properties of the first matrix material 56, increased wear of the first matrix material 56 on the side surfaces of the machining segment 51 can occur during the machining of a substrate with the machining segment 51 as a result of friction with the substrate. This wear is reduced by the second hard material particles 58.

The first and second hard material particles 57, 58 generally originate from particle distributions which are characterized by a minimum diameter, a maximum diameter and an average diameter. In the exemplary embodiment of FIGS. 5A-C, the first hard material particles 57 originate from a first particle distribution with a first average diameter and the second hard material particles 58 originate from a second particle distribution with a second average diameter, the first average diameter being greater than the second average diameter. Alternatively, the first and second hard material particles 57, 58 may originate from the same particle distribution and have the same average diameter.

The machining segment 51 is connected by an underside 61 to the basic body of a machining tool. In the case of the machining segment 51 shown in FIG. 5C, the first hard material particles 57 are arranged according to the defined first particle pattern in a number of particle layers in the first matrix material 56 and the second hard material particles 58 are arranged according to the defined second particle pattern on the side surfaces of the machining segment 51. The substrate is machined via first hard material particles 57 which are arranged on an upper side 62 of the machining segment 51 opposite from the underside 61.

The green body 52 shown in FIG. 5A is built up in the horizontal structure from the first matrix material 56, the first hard material particles 57, the second hard material particles 58, the second matrix material 59 and a powdered or granular supporting material 63. The supporting material 63 is different from the first matrix material 56 and serves for covering the second hard material particles 58 during pressing. The state of the supporting material 63 is adapted to the state of the first matrix material 56, i.e. in the case of a powdered first matrix material 56 a powdered supporting material 63 is used and in the case of a granular first matrix material 56 a granular supporting material 63 is used.

The green body 52 is compacted under the action of pressure between a first press punch 64, which forms a first side surface 65, and a second press punch 66, which forms a second side surface 67, until the compact body 53 has substantially the final geometry of the machining segment 51. The pressing direction of the first and second press punches 64, 66 runs between the first and second side surfaces 65, 67. Examples of suitable methods for achieving an action of pressure on the green body 52 are cold-pressing methods or hot-pressing methods. In the case of cold-pressing methods, the green body 52 is exclusively subjected to an action of pressure, while in the case of hot-pressing methods the green body 52 is subjected not only to the action of pressure but also to an action of temperature up to temperatures of about 200° C.

The compact body 53 is further processed to form the machining segment 51 by free-form sintering or hot pressing. In the case of free-form sintering, there is an action of temperature on the compact body 53 and in the case of hot pressing there is an action of pressure and temperature. If the compact body 53 is further processed by freeform sintering, the green body 52 is compacted until the compact body 53 has substantially the final geometry of the machining segment 51. If the compact body 53 is further processed by hot pressing, the compact body 53 is shaped further during hot pressing.

The properties of the supporting material 63, in particular the melting temperature Tₘₑₗₜ, determine the behavior of the supporting material 63 during further processing. If the melting temperature Tₘₑₗₜ of the supporting material 63 is lower than the sintering temperature Tₛᵢₙₜₑᵣ of the first matrix material 76, the supporting material 63 changes its powdered or granular state when it is heated up and liquefies before the first matrix material 56 is sintered; the liquid supporting material 63 can distribute itself in the first matrix material 76 during the sintering process and support the sintering process as an infiltrate. If the melting temperature Tₘₑₗₜ of the supporting material is higher than the sintering temperature Tₛᵢₙₜₑᵣ of the first matrix material 56, the supporting material 63 remains in its powdered or granular state when it is heated up and can be removed from the finished machining segment without any problem after the sintering process.

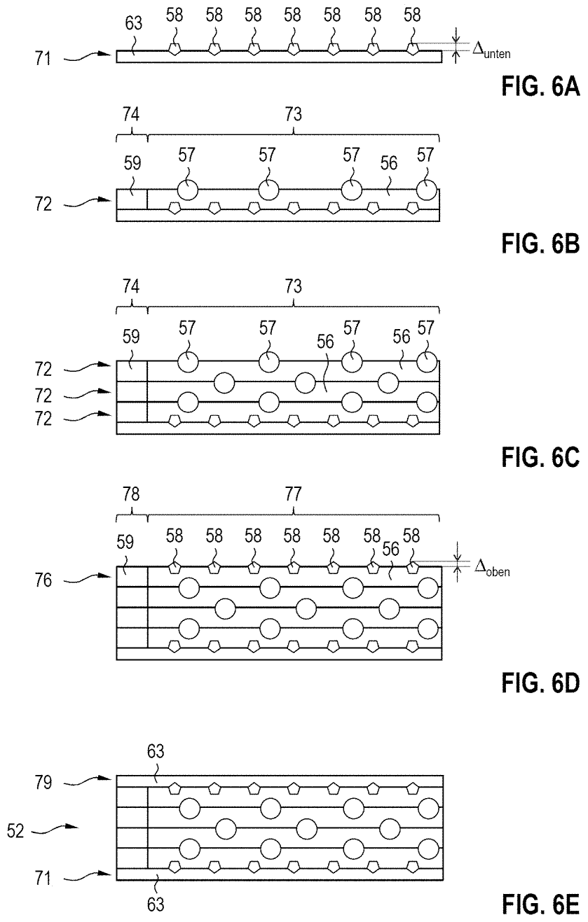

FIGS. 6A-E show the production of the green body 52 by means of the method according to the invention for producing a green body. The green body 52 is built up from the first matrix material 56, the first hard material particles 57, the second hard material particles 58, the second matrix material 59 and the supporting material 63.

The green body 52 is produced in a number of steps: in a first step, a lower layer 71 of the supporting material 63 is applied, it being possible for the lower layer 71 to be applied in one layer or in a number of layers. In a second step, the second hard material particles 58 are arranged in the supporting material 63 according to the defined second particle pattern, the second hard material particles 58 not being completely embedded in the supporting material 63 but having a projection Δ_{lower} with respect to the supporting material 63 (FIG. 6A).

After the second hard material particles 58 have been arranged, the first and second matrix materials 56, 59 are applied and the first hard material particles 57 are arranged in the first matrix material 56 in a sequence of a third and a fourth step (first and second sequential steps), it being possible for the sequence to be carried out one or more times (N times with N≥1). In the first sequential step, a matrix layer 72 consisting of a first region 73 and a second region 74 is applied, the first matrix material 56 being applied in the first region 73 and the second matrix material 59 being applied in the second region 74; in the case of the green body without a neutral zone, there is no need for the second region 74. In the second sequential step, the first hard material particles 57 are arranged in the first matrix material 56 according to the defined first particle pattern (FIG. 6B). In case of the green body 52, the sequence of the first and second steps is carried out three times. FIG. 6C shows the green body 52 after the third sequence.

Once the first hard material particles 57 have been arranged in the third matrix layer, an upper matrix layer 76 consisting of a first region 77 and a second region 78 is applied, the first matrix material 56 being applied in the first region 77 and the second matrix material 59 being applied in the second region 78. The second hard material particles 58 are arranged in the upper matrix layer 76 according to the defined second particle pattern, the second hard material particles 58 partially embedded in the first matrix material 56 and having a projection Δᵤₚₚₑᵣ with respect to the first matrix material 56 (FIG. 6D). Finally, an upper layer 79 of the supporting material 63 is applied, the second hard material particles 58 being completely covered by the supporting material 63 (FIG. 6E).

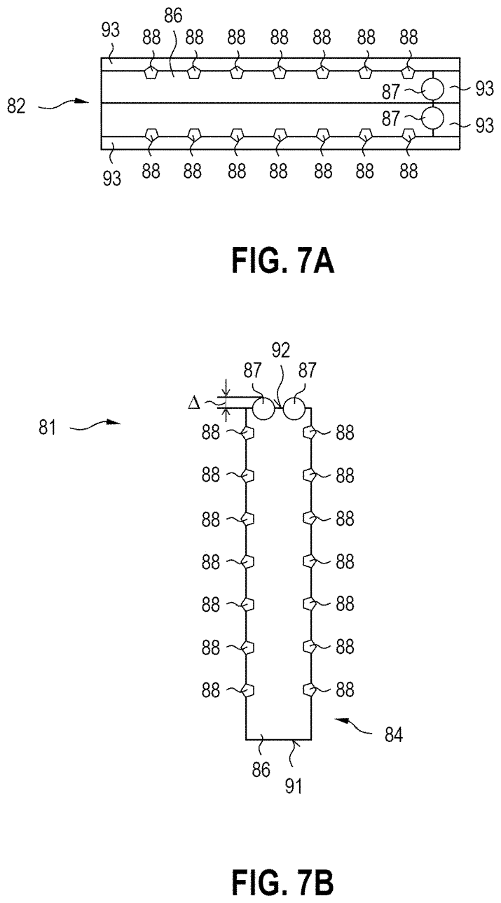

FIGS. 7A, B show a machining segment 81 produced by the method according to the invention for producing a green body and the method for further processing the green body to form the machining segment. The machining segment 81 is in this case produced in two stages: In a first stage, a green body 82 is produced (FIG. 7A) and, in a second stage, the green body 82 is further processed to form the machining segment 81 (FIG. 7B).

The machining segment 81 differs from the machining segment 51 of FIG. 5C by the fact that the machining segment 81 is built up from a machining zone 84 and does not have a neutral zone. The machining zone 84 is built up from a powdered or granular first matrix material 86, first hard material particles 87, which are arranged according to a defined first particle pattern, and second hard material particles 88, which are arranged according to a defined second particle pattern.

The first hard material particles 87 and second hard material particles 88 generally originate from particle distributions which are characterized by a minimum diameter, a maximum diameter and an average diameter. In the exemplary embodiment of FIGS. 7A, B, the first hard material particles 87 originate from a first particle distribution with a first average diameter and the second hard material particles 88 originate from a second particle distribution with a second average diameter, the first average diameter being greater than the second average diameter. Alternatively, the first hard material particles 87 and second hard material particles 88 may originate from the same particle distribution and have the same average diameter.

The machining segment 81 is connected by an underside 91 to the basic body of a machining tool. A substrate is machined by first hard material particles 87, which are arranged on an upper side 92 opposite from the underside 91. In the finished machining segment 81, the first hard material particles 87 have a projection A with respect to the first matrix material 86.

The green body 82 is produced analogously to the production of the green body 52, the application of the second matrix material being dispensed with. The green body 82 is built up from the first matrix material 86, the first hard material particles 87, the second hard material particles 88 and a powdered or granular supporting material 93. The supporting material 93 is different from the first matrix material 86 and serves for covering the first hard material particles 87 on the upper side 92. The state of the supporting material 93 is adapted to the state of the first matrix material 86, i.e. in the case of a powdered first matrix material 86 a powdered supporting material 93 is used and in the case of a granular first matrix material 86 a granular supporting material 93 is used.

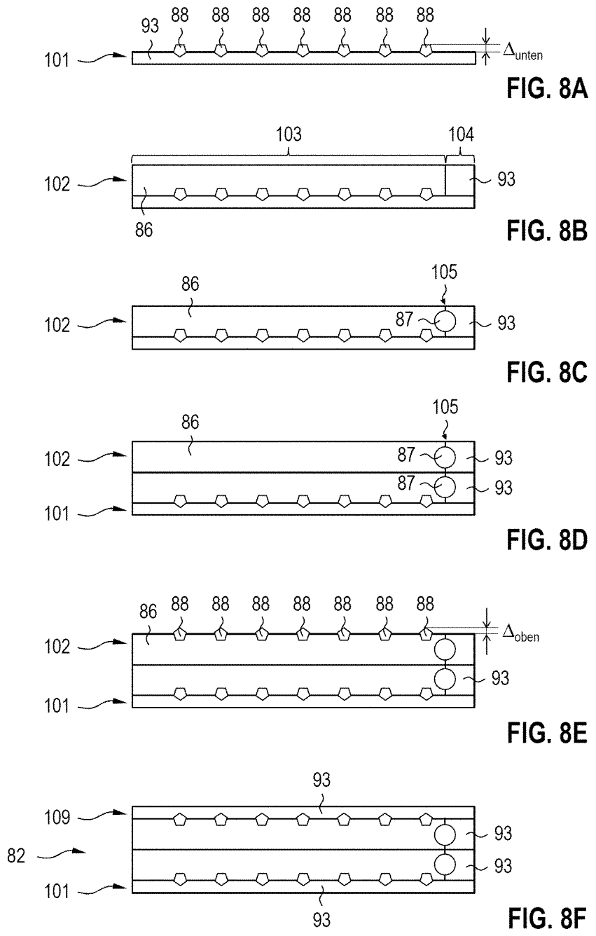

FIGS. 8A-F show the production of the green body 82 by means of the method according to the invention for producing a green body. The green body 82 is built up from the first matrix material 86, the first hard material particles 87, which are arranged according to the defined first particle pattern, the second hard material particles 88, which are arranged according to the defined second particle pattern, and the supporting material 93.

The production of the green body 82 starts by a lower layer 101 of the supporting material 93 being applied and the second hard material particles 88 being arranged in the supporting material 93 according to the defined second particle pattern, the second hard material particles 88 not being completely embedded in the supporting material 93 but having a projection Δ_{lower} with respect to the supporting material 93 (FIG. 8A).

After the second hard material particles 88 have been arranged, the first matrix material 86 and the supporting material 93 are applied and the first hard material particles 87 are arranged in the first matrix material 86 in a sequence of a first step and a second step, which can be carried out once or multiple times (N-fold with N≥1). In the first step of the sequence, a matrix layer 102 comprising a first region 103 and a second region 104 is applied, the first matrix material 86 being applied in the first region 103 and the supporting material 93 being applied in the second region 104 (FIG. 8B), and in the second step of the sequence, the first hard material particles 87 are arranged in the matrix layer 102 according to the defined first particle pattern, the first hard material particles 87 being arranged in a transitional region 105 between the first region 103 and second region 104 (FIG. 8C). In the case of the green body 82, the sequence of the first and second steps is carried out twice; FIG. 8D shows the green body 82 after the second sequence.

Once the first hard material particles 87 have been arranged in the second matrix layer 102, the second hard material particles 88 are arranged in the second matrix layer 102 according to the defined second particle pattern, the second hard material particles 88 being partially embedded in the first matrix material 86 and having a projection Δᵤₚₚₑᵣ with respect to the first matrix material 86 (FIG. 8E). Finally, an upper layer 109 of the supporting material 93 is applied, the second hard material particles 88 being completely covered by the supporting material 93 (FIG. 8F).

1-9. (canceled)

10: A method for producing a green body for a machining segment from a powdered or granular first matrix material, first hard material particles and second hard material particles, the machining segment being connected by an underside to a basic body of a machining tool, the method comprising the following steps:
applying a lower layer of a powdered or granular supporting material different from the first matrix material;
arranging the second hard material particles in the lower layer according to a defined second particle pattern, the second hard material particles being partially embedded in the supporting material;
performing a sequence of a first and a second sequential step performed N times, N≥1, wherein
in the first sequential step, a matrix layer having a first region is applied, wherein the first matrix material is applied in the first region, and
in the second sequential step, the first hard material particles are arranged in the matrix layer according to a defined first particle pattern;
arranging the second hard material particles in the Nth matrix layer according to the defined second particle pattern, wherein the second hard material particles are partially embedded in the first matrix material, and
applying an upper layer of the supporting material, wherein the second hard material particles are completely covered by the supporting material.

11: The method as recited in claim 10 wherein the first hard material particle are arranged in the first matrix material according to the defined first particle pattern.

12: The method as recited in claim 10 wherein the matrix layer includes the first region and a second region, the supporting material being applied in the second region, and the first hard material particles being arranged in a transitional region between the first region (and the second region.

13: The method as recited in claim 12 wherein the supporting material applied in the second region of the matrix layer has a melting temperature higher than the sintering temperature of the first matrix material applied.

14: The method as recited in claim 12 wherein the supporting material applied in the second region of the matrix layer has a melting temperature lower than the sintering temperature of the first matrix material applied.

15: A method for forming a machining segment, the method comprising:
further processing the green body produced by the method as recited in claim 10 to form the machining segment.

16: The method as recited in claim 15 wherein the further processing includes compacting the green body under the action of pressure to form a compact body and further processing the compact body to form the machining segment (51).

17: The method as recited in claim 16 wherein the compact body is further processed to form the machining segment by free-form sintering or hot pressing.

18: The method as recited in claim 15 wherein the green body is further processed to form the machining segment by free-form sintering or hot pressing.
